(19) United States
(12) Patent Application Publication
(10) Pub. No.: US 2005/0145330 A1
(43) Pub. Date: Jul. 7, 2005

(54) Transmission laser welding of electro-chemical sensors

(76) Inventors: Gary Shubinsky, Mission Viejo, CA (US); Shankar Baliga, Irvine, CA (US)

Correspondence Address: Law Offices of Larry K. Roberts, P.O. Box 8569, Newport Beach, CA, 92658-8569, US

(21) Appl. No.: 10/745,727

(22) Filed: Dec. 24, 2003

(51) Int. Cl. B32B 31/00

(52) U.S. Cl. 156/272.8

(57) ABSTRACT

A method and apparatus for the fabrication of an electro-chemical sensor housing structure. A plastic cover member is positioned in contact with a sensor housing structure. The housing structure fabricated of a plastic material with high absorption to laser radiation. Laser energy is transmitted through the cover member, fabricated of a material that transmits the laser energy, onto a weld area at a joint between the cover member and the housing structure to weld the cover member to the housing structure at the joint.

### BACKGROUND

Electro-chemical sensors are used extensively for the detection of industrial toxic gases. Toxic gases are typically measured in the parts per million range (ppm) for human safety. Typical gases and instrument ranges (full scale) include: carbon monoxide (100 and 500 ppm), chlorine (10 and 20 ppm), chlorine dioxide (3 ppm), hydrogen chloride (20 ppm), nitric oxide (100 ppm), nitrogen dioxide (20 ppm), ammonia (50 and 100 ppm), ozone (1 ppm), sulfur dioxide (20 ppm) and hydrogen sulfide (20 ppm). In addition, electro-chemical sensors are used for the monitoring of oxygen deficiency for personal safety. Industrial safety instrumentation based on these sensors can produce an alarm when the oxygen level drops below a certain percentage, for example, 19.5% by volume is considered the minimum safe level of oxygen.

A typical electro-chemical sensor includes a plastic enclosure, which houses such elements as electrodes, electrolyte, various membranes and wicking material. The housings of currently available electro-chemical cells include a bottom part and a top cover. These two parts are fused together to form a cell housing; the gas diffuses through openings and membranes in the top cover.

Cell performance and integrity strongly depends on the design of the housing and the type of encapsulation. There are a number of methods that are currently used for the fabrication of electro-chemical sensors, including: mechanical “snap fit”, ultrasonic welding of the top and bottom parts, epoxy and chemical solvent bonding. All of these techniques have significant shortcomings.

### BRIEF DESCRIPTION OF THE DRAWINGS

Features and advantages of the disclosure will readily be appreciated by persons skilled in the art from the following detailed description when read in conjunction with the drawing wherein:

FIG. 1 is an isometric view of an embodiment of a laser-welded electrochemical sensor.

FIG. 2 is a side cross-sectional view taken along line 2-2 of FIG. 1, showing internal construction features of the sensor of FIG. 1.

FIG. 3 shows an exemplary laser welding system for transmission laser welding of a sensor cover to a sensor body structure.

FIG. 4 is a graph showing transmission properties of clear polycarbonate.

FIG. 5 is a schematic block diagram of an exemplary laser welding system for sealing a sensor cover to a sensor body structure.

FIG. 6 is a flow diagram illustrating an exemplary embodiment of a process flow for fabricating an electro-chemical sensor using a laser welding technique.

### DETAILED DESCRIPTION

In the following detailed description and in the several figures of the drawing, like elements are identified with like reference numerals.

Nd:YAG and diode lasers produce optical energy in the near-infrared wavelength region of 800-1100 nanometers. Radiation at these wavelengths can actually penetrate inside a plastic part. The depth of the laser penetration is a function of the laser wavelength and the optical properties of the selected plastic. Currently, high power diode lasers are available at wavelengths of 808 nm, 940 nm and 980 nm, and can deliver the 5 to 50 Watts of energy for welding plastics. The laser beam can be transmitted using a wide spectrum of optical systems, including reflective optics, refractive optics, and fiber-optic elements. To assure optimal energy absorption conditions, the optical properties of a polymer can be altered by the addition of an absorber (carbon black or absorbing pigments).

Precision laser welding of thin and/or thick plastic parts and components has the advantage that laser welding can be performed exactly where it is required at the interface between pre-assembled parts in a well-defined manner. Direct contact between parts held under pressure ensures heating of both materials at the interface; welding occurs upon the localized melting and fusion of materials at the interface.

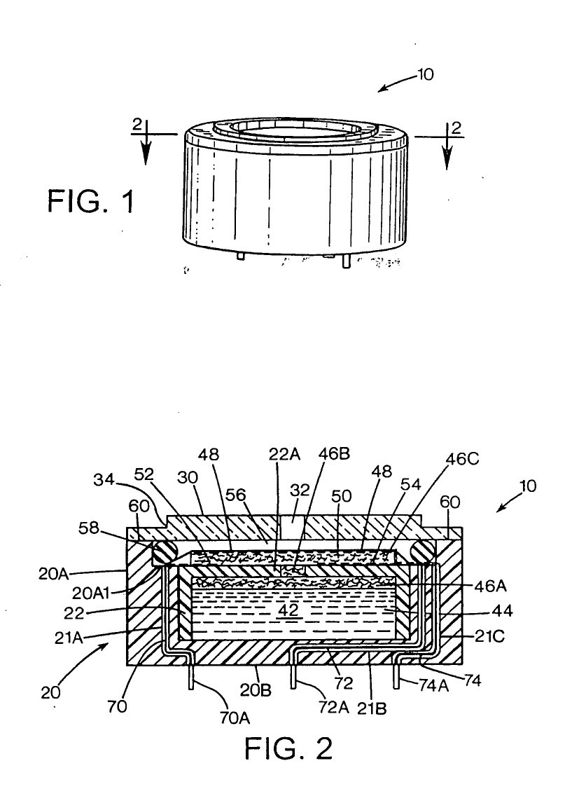

FIGS. 1-2 show an exemplary embodiment of an electro-chemical sensor 10, which can be assembled using a laser welding technique in accordance with an aspect of the invention. The sensor 10 in this exemplary embodiment comprises an opaque plastic bottom housing structure 20, which has a cylindrical side wall portion 20A and a flat bottom wall portion 20B. Typically the plastic material from which the housing structure is fabricated is a black material, although some other colors will also be satisfactory. The plastic material is opaque at the laser welding wavelength.

A plastic electrolyte cover 22, which in an exemplary embodiment has an inverted cup-like shape with an opening 22A, is placed in the bottom housing, forming an electrolyte reservoir 42 holding an electrolyte liquid or gel 44. A layer portion 46A of wicking material is positioned at the top of the reservoir, with another layer portion 46B positioned in the opening 22A. A third layer portion 46C of wicking material is positioned over the opening 22A in space 56. The wicking material can comprise a cotton wick or glass fiber wick, by way of example. An electrically conductive sensing electrode (with catalyst) having, in an exemplary embodiment, a generally circular shape, is fabricated, e.g. screen printed, on a Teflon membrane, collectively shown as layer 48, forming a top electrode structure. In an exemplary embodiment, an electrically conductive reference electrode 52 and an electrically conductive spaced counter electrode 54 are fabricated on another Teflon membrane, forming a bottom electrode structure. The top and bottom electrode structures are separated by the layer portion 46C. In this exemplary embodiment, the reference electrode and the counter electrode each have a generally half-circular configuration, with a gap formed between adjacent edges. The opening 22A in the cover 22 permits the electrolyte 44 to wick by capillary action from the reservoir into the wicking material layers, and provide an electrically conductive path between the electrodes 48 and 52, 54. In an exemplary embodiment, the conductivity of the path is increased by the reaction of the gas with the electrodes.

An optically transparent clear top housing cover 30 is sealed to the bottom housing structure 20 by laser welding, as will be described below. The top cover 30 has an opening formed there through, permitting ambient air to pass through the cover to the interior 56 of the housing structure 20. The diameter and length of the opening controls the flow of ambient air into the sensor. A dust cover (not shown) may be placed over the opening 32 in some applications, while still allowing gas to pass into the housing.

Electrical contact to the electrode structures 48, 52, 54 is made, in this exemplary embodiment, by wire ribbons 70, 72, 74, fabricated of an electrical conductive material such as platinum. The wire ribbons are passed through holes or channels 21A, 21B, 21C formed in the housing structure 20 to make electrical contact between terminals 70A, 70B, 70C and respective ones of the electrode structures 48, 52, 54. The holes or channels 21A, 21B, 21C are filled with epoxy after the wires are inserted to prevent electrolyte leakage.

The sensor components disposed within the housing 20 thus include in this exemplary embodiment the electrolyte 44 disposed in the reservoir 42, the reference and counter-electrode structure 52, 54, wicking material 46A-46C, and the sensing electrode (with catalyst) 48. It will be appreciated that these components are merely exemplary; other electro-chemical sensors may have a different set of components.

An elastomeric o-ring seal 58 is positioned at the top of the structure 20, forming a seal between the body structure 20 and the cover 30. The o-ring seal 58 prevents the leakage of electrolyte from the housing structure.

The cover 30 in this exemplary embodiment is joined to the body structure 20 at laser welding area 60 by a process described below. The laser weld bond is at the mating surface between the top cover and the bottom housing, covering a one to two millimeter wide annular ring at the outer diameter of the package in an exemplary embodiment. The thickness of the cover in this embodiment is reduced at the periphery to form a step or shoulder 34. Other configurations for the body structure and cover may alternatively be employed; for example the body structure and cover may have a rectilinear footprint rather than a circular configuration as shown in FIG. 1.

The top cover is attached to the bottom housing by a laser welding processes. Edges of the Teflon membranes are positioned on a shoulder area 20A1 of the wall 20A. The o-ring 58 is compressed between the cover and the Teflon membranes carrying the electrode structures supported by the shoulder area 20A1, providing a fluid seal between the housing 20 and cover 30. In one exemplary embodiment, the weld between the cover and body structure is made for mechanical attachment, with the o-ring 58 providing the fluid seal. Providing a continuous weld bond about the periphery is good manufacturing practice, and increases reliability and bond strength. In an exemplary embodiment, the weld is a continuous one about the entire 360 degree perimeter, with a weld overlap of 5 to 10 degrees; i.e. the end of the weld process finishes 5 to 10 degrees past its start point so that the end of the welding process overlaps onto areas already welded. For some applications, the o-ring 58 may be omitted, with the laser weld joint a continuous peripheral joint to provide a fluid seal.

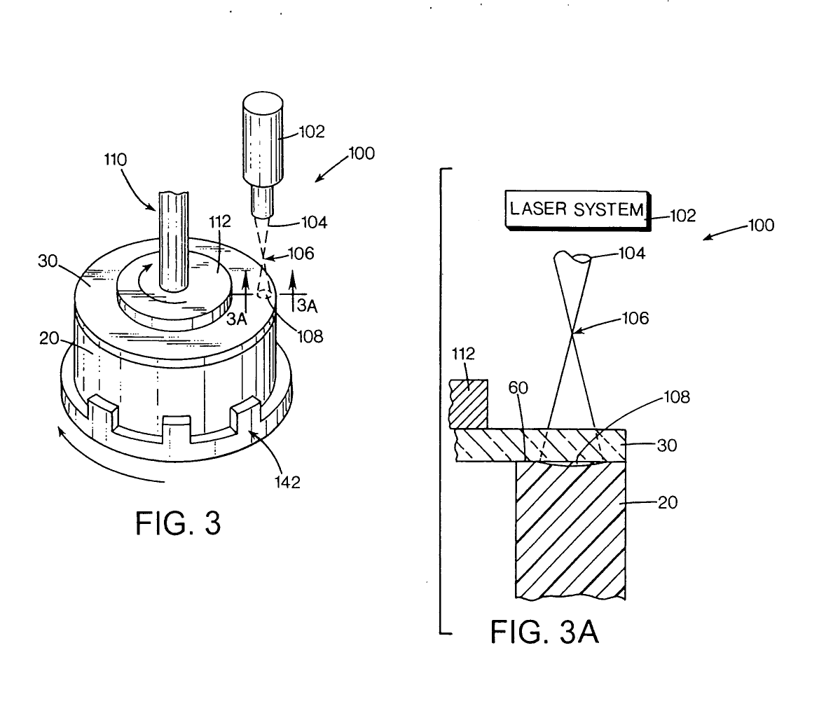

FIGS. 3 and 3A diagrammatically illustrate an exemplary laser welding system 100 for transmission laser welding of the cover 30 to the body structure 20. The sensor components are assembled into the housing and the cover is positioned in place on the body structure 20. The body structure 20 is mounted on a fixture including, in this example, a rotatable turntable 142, with the cover 30 positioned in place. The optically transparent cover 30 and the opaque body structure 20 are clamped together by a clamp system 110 comprising a clamp structure 112 which pushes down against the cover and body structure, which is supported by the turntable. The o-ring 58 is now compressed, forming the fluid seal. A laser system 102 generates a beam 104, with a beam focus location at 106. The width of the weld is determined by its distance from the beam focus position; a defocused condition produces a wider weld than a focused condition. The minimum spot size is typically 0.5 mm. The pieces are clamped together; the clamping structure 110 can include a plate formed of an optically clear glass or plastic, in the case in which the parts are to be clamped directly above the weld region. In this exemplary embodiment, the turntable and clamp system provide relative motion between the clamped pieces and the laser beam. In other embodiments, arrangements can be employed to move the laser beam in relation to the clamped pieces, or an array of spatially separated laser beams employed.

The housing 20 is made of an optically absorbing material, e.g. a plastic material having dyes or carbon black added to make the material opaque. One exemplary material suitable for the purpose is black ABS, which has high optical absorption in the spectral bands of the laser radiation. This high optical absorption is due to the pigments present in the plastic. The body structure can be fabricated of plastic materials with additives to make it opaque to the laser radiation, and with an appropriate melting temperature to support consistent fusion of the parts.

The plastic cover 30 is made of an optically transparent plastic, such as, by way of example, polycarbonate, acrylic or clear ABS. Optically translucent or semi-opaque plastics such as natural ABS can also be used, provided the material and thickness are such as to transmit sufficient laser energy to the weld interface.

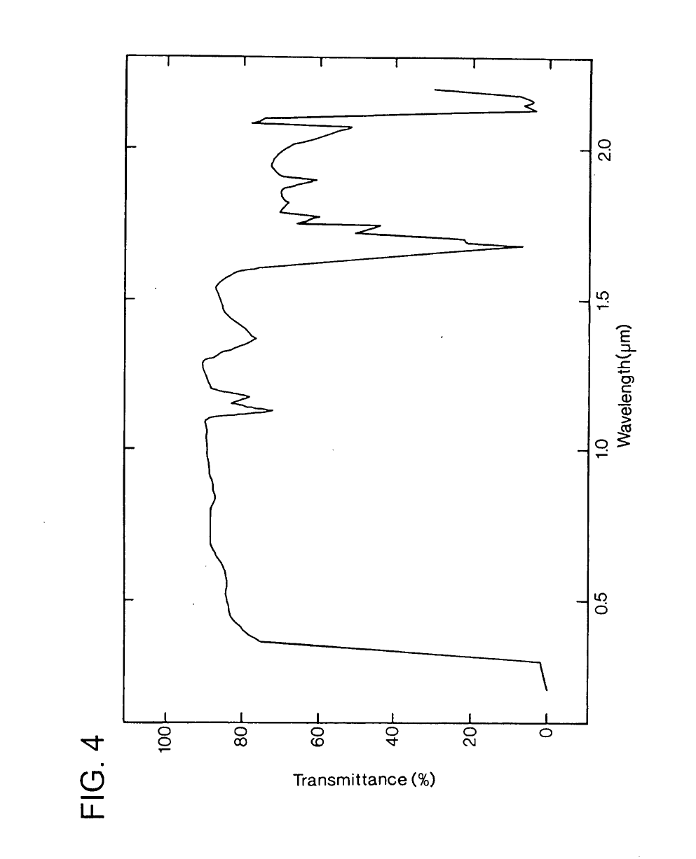

FIG. 4 shows the transmission properties of clear polycarbonate; note the high transmission between 0.5 and 1.0 microns wavelength limited only by reflective or Fresnel losses. This is a wavelength range where high power diode lasers are readily available.

It is possible to select plastic materials that satisfy chemical resistance requirements, which are mandatory for industrial electro-chemical sensors, and also satisfy the optical transmittance characteristics required for laser welding. For adequate laser energy transmission, the top cover 30 is typically no more than a few millimeters thick, and in an exemplary embodiment, from 1 mm to 3 mm at the weld joint area, i.e. the area of the cover through which the laser beam is transmitted to reach the joint. In the embodiment shown in FIG. 2, the cover thickness is reduced at the weld joint area, so that the cover in the region interior of the weld is thicker than at the weld joint area. This allows increased cover strength and rigidity, while facilitating transmission of laser energy to the weld joint. Relative motion is provided between the laser and the workpiece to form the weld over the desired weld area. For example, the workpiece can be moved on a programmable, servo-driven X-Y table, a rotating stage (for circular welds), or the laser can be moved on a robot or gantry. More complex systems using masks, scanning mirrors and arrays of diode lasers can be employed. Also, overlapping concentric rings of welding can be performed to ensure proper welds.

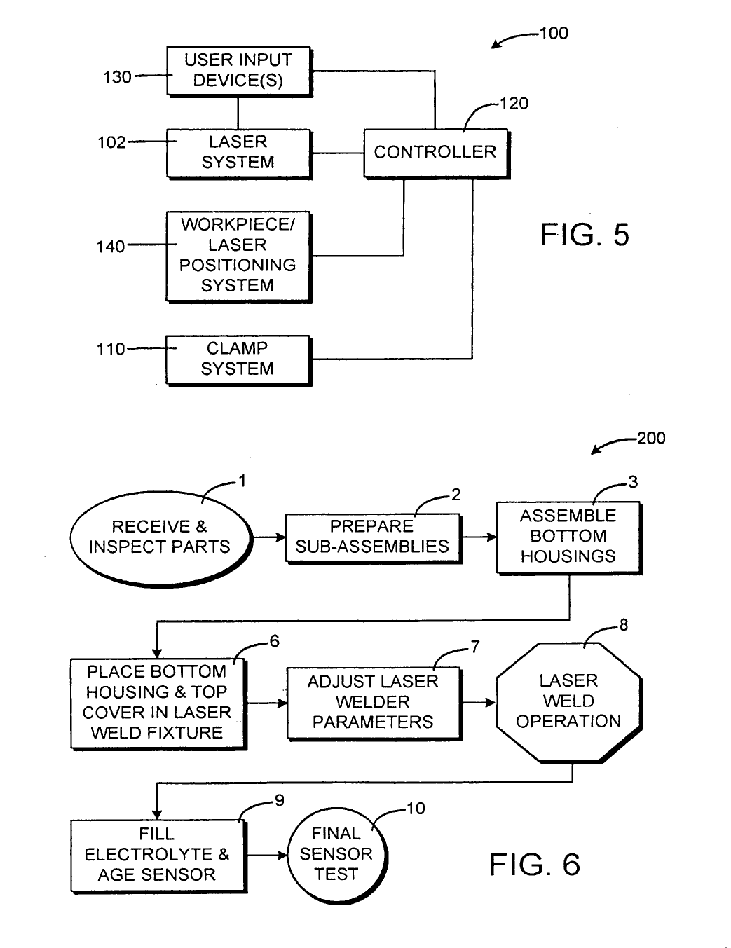

FIG. 5 is a schematic block diagram of the laser welding system 100, comprising the laser system 102. A controller system 120 controls the laser system 102 and a workpiece/laser positioning system 140, comprising in one exemplary embodiment the turntable 142, to carry out laser welding operations for joining a cover to a sensor housing. The controller 120 can act in response to commands entered through a user input device, such as a keyboard, switch or other device. In some applications, the controller can be implemented by a personal computer. Alternatively, the controller could be implemented through logic circuitry. A manual system can alternatively be employed, e.g., wherein an operator controls directly the laser system, and moves the workpiece in relation to the laser (or vice versa) to perform the welding. The controller 120 can also be set up to control the clamping system, which can include, e.g. a pneumatic cylinder or solenoid actuator coupled to a plate 112 (FIG. 3).

FIG. 6 is a flow diagram illustrating an exemplary embodiment of a process flow for fabricated an electro-chemical sensor using a laser welding technique. At 1, the sensor components are received and inspected. At 2, the sensor sub-assemblies are prepared, e.g., the electrolyte cover, wicking layers, electrode structures, and wires, with the o-ring seal, and then assembled to the bottom housing structure at 3. At 4, the bottom housing structure and the top cover are placed in a laser weld fixture, and clamped in place. The clamping also serves to compress the o-ring between the cover and surfaces of the bottom housing. At 7, the laser welder parameters are adjusted, if necessary. In transmission laser welding, the main parameters are laser power, geometrical profile of the laser beam, welding speed, optical and thermal properties of the plastic materials, and clamping pressure. Typically, for a given sensor design, the plastic material properties will be unchanging from sensor batch to sensor batch, so that for a given sensor design, the parameter settings will be known. At 8, the laser weld operation is conducted, attaching the cover to the housing. This can include providing relative motion between the laser beam and the clamped parts, to provide a continuous weld area attaching the cover to the body structure. The electrolyte reservoir of the sensor is then filled with the electrolyte at step 9, via a hole in the bottom of the housing (not shown), which is subsequently plugged. The completed sensor is then tested at 10.

Exemplary sensor laser welding examples include the following. For an exemplary carbon monoxide sensor, the bottom housing is fabricated of black ABS, and the top cover is fabricated of clear polycarbonate. A 50-Watt solid-state laser at 940 nm is the welding laser, with a spot size of 0.6 mm. The speed of relative motion between the laser beam and the part is typically about 36 degrees per second of rotational motion, with a clamping pressure of 100 psi and laser power of 10 Watts. For an exemplary oxygen sensor, the top cover is fabricated of natural ABS, which scatters as well as absorbs some laser radiation; the bottom housing is fabricated of black ABS. Since the cover scatters and absorbs some laser radiation, greater laser power, e.g. 25 Watts, is employed. The parameters will also depend on the laser spot size.

Compared to other methods of bonding such as ultrasonic welding, transmission laser welding has several advantages for electro-chemical sensors, including the following:
Elimination of the complex ultrasonic energy director: this results in a lower cost, simpler mechanical design for the bottom housing and top cover.
Little or no weld flash: where cosmetic appearance is concerned, laser welding is superior.
Low tooling costs: clamping fixtures customized for each sensor type are simple compared to the ultrasonic horn and booster.
Rapid changeover for different sensor designs: laser weld parameters stored in a computer are changed along with the clamping fixture, if required.
Mechanical or thermal damage to other parts of the sensor such as capillaries, electrodes and housing is reduced or eliminated; the laser weld process limits the heat strictly to the weld area, improving yield.
In-process quality control is possible via non-contact, non-invasive real-time infrared thermometry and accurate measurement of the heat distribution produced by the laser radiation. A visible alignment laser can assist the operator in tracking the position of the laser beam.
Little or no damage to the parts being welded. The method offers extremely high levels of welding consistency and weld quality. Near 100% yield can be achieved.
Long operating life and low maintenance: diode lasers have lifetime measured in thousands of hours which compares very favorably to the few seconds required for a sensor weld. There is also no mechanical wear and tear since laser welding is a non-contact process.

Although the foregoing has been a description and illustration of specific embodiments of the invention, various modifications and changes thereto can be made by persons skilled in the art without departing from the scope and spirit of the invention as defined by the following claims.

1. A method for attaching a cover to an electro-chemical sensor housing structure, comprising:
positioning a plastic cover member onto a sealing position in contact with a sensor housing structure for an electro-chemical sensor, said housing structure fabricated of a plastic material which is opaque to energy at a laser wavelength or wavelength range;
transmitting laser energy through the cover member onto a weld area at a joint between the cover member and the housing structure to weld the cover member to the housing structure by localized fusion at said joint.

2. The method of claim 1, wherein said positioning the plastic cover member onto the sealing position in contact with the sensor housing includes:
applying pressure between the cover member and the sensor housing.

3. The method of claim 2, further comprising:
positioning an elastomeric sealing element inside the housing structure; and
wherein said applying pressure between the cover member and the sensor housing compresses the elastomeric sealing element between the cover and the housing structure, forming a fluid seal.

4. The method of claim 3, wherein the elastomeric sealing element includes an o-ring.

5. The method of claim 1 wherein said cover includes a perimeter, and method further comprises:
providing relative motion between the cover member and the laser energy to provide a continuous laser weld along the perimeter.

6. The method of claim 5, wherein said continuous laser weld circumscribes said perimeter.

7. The method of claim 6, wherein said perimeter is a circular perimeter.

8. The method of claim 1, wherein said cover is fabricated from clear polycarbonate, and said laser energy is in a wavelength range between 0.5 and 1.0 microns wavelength.

9. The method of claim 8, wherein said sensor is a carbon monoxide sensor, and further comprising:
assembling an electrolyte reservoir structure, a wicking structure and electrode structures within the sensor housing prior to said positioning.

10. The method of claim 9 wherein said laser energy is generated by a solid state laser at a wavelength of 940 nm.

11. The method of claim 1, wherein said laser energy has a nominal spot size at the weld area of about 0.5 mm.

12. The method of claim 1, further comprising disposing electrolyte into the sensor housing.

13. The method of claim 1, wherein said transmitting laser energy through the cover member includes transmitting laser energy through a peripheral region of said cover having a reduced thickness relative to a cover thickness interior of said peripheral region.

14. The method of claim 13, wherein said plastic is polycarbonate, and said reduced thickness is in a range of 1 mm to 3 mm.

15. The method of claim 1, wherein said laser energy is in a wavelength range between 800 nanometers and 1100 nanometers.

16. An electrochemical sensor fabricated according to the method of claim 1.

17. The sensor of claim 16, wherein said sensor is a toxic gas sensor.

18. A method for fabricating an electro-chemical sensor, comprising:
installing sensor sub-assembly structures in a housing body structure, said housing structure fabricated of a plastic material which is opaque to energy at a laser wavelength or wavelength range;
placing the housing body structure in a laser welding fixture;
positioning a plastic cover member onto a sealing position in contact with the housing body structure;
transmitting laser energy through the cover member onto a weld area at a joint between the cover member and the housing body structure to weld the cover member to the housing body structure at said joint.

19. The method of claim 18, wherein said positioning the plastic cover member onto the sealing position in contact with the housing body structure includes:
applying pressure to the cover member to urge the cover member against the sensor housing.

20. The method of claim 18 wherein said cover includes a perimeter, and method further comprises:
providing relative motion between the cover member and the laser energy to provide a continuous laser weld along the perimeter.

21. The method of claim 20, wherein said continuous laser weld circumscribes said perimeter.

22. The method of claim 21, wherein said perimeter is a circular perimeter.

23. The method of claim 20, wherein said perimeter of said cover has a reduced thickness relative to a cover thickness interior of said perimeter.

24. The method of claim 23, wherein said reduced thickness is in a range of 1 mm to 3 mm.

25. The method of claim 18, wherein said cover is fabricated from clear polycarbonate, and said laser energy is in a wavelength range between 0.5 and 1.0 microns.

26. The method of claim 18, wherein said laser energy has a nominal spot size at the weld area of about 0.5 mm.

27. The method of claim 18, further comprising:
installing an elastomeric o-ring within the housing body structure;
applying pressure on the cover to urge the cover into contact with a surface of the housing body structure and compress the o-ring while said laser energy is transmitted through the cover.

28. The method of claim 18, further comprising:
filling a reservoir in the housing body structure with an electrolyte after said cover member has been welded to said housing body structure.

29. An electrochemical sensor fabricated according to the method of claim 17.

30. The sensor of claim 29, wherein said sensor is a toxic gas sensor.
